(19) United States
(12) Patent Application Publication
(10) Pub. No.: US 2026/0246175 A1
(43) Pub. Date: Aug. 20, 2026

(54) CONNECTOR

(71) Applicant: SUMITOMO WIRING SYSTEMS, LTD., Mie (JP)

(72) Inventors: Junpei KAWAHARA, Mie (JP); Tomoki SUZUKI, Mie (JP)

(21) Appl. No.: 19/536,904

(22) Filed: Feb. 11, 2026

(30) Foreign Application Priority Data
Feb. 17, 2025 (JP) 2025-022983

(51) Int. Cl. H01R 12/71; H01R 13/41; H01R 13/422; H01R 13/436; H01R 13/629

(52) U.S. Cl. CPC H01R 12/716; H01R 13/41; H01R 13/422; H01R 13/4223; H01R 13/4362; H01R 13/629

(57) ABSTRACT

A housing includes: a wall portion with a thickness in a first direction; a retaining hole that extends inside the wall portion in the first direction; guide surfaces that extend at an angle from a first surface in the first direction of the wall portion toward a second surface so as to approach each other in a second direction that intersects the first direction; facing surfaces that face in a same direction as the first surface and that are disposed to form a pair in a third direction that intersects the first direction and the second direction at an intermediate part in the first direction of the wall portion; and movement suppression surfaces that extend along the first direction between the guide surfaces of the wall portion and the facing surfaces. A terminal fitting includes: a retained portion that is held in the retaining hole; and stopper portions.

### CROSS-REFERENCE TO RELATED APPLICATIONS

This application is based on and claims priority from Japanese Patent Application No. 2025-022983, filed on February 17, 2025, with the Japan Patent Office, the disclosure of which is incorporated herein in its entirety by reference.

### TECHNICAL FIELD

The present disclosure relates to a connector.

### BACKGROUND

JP 2021-114378 A discloses a connector including a housing and terminal fittings. The terminal fittings include board connection portions that are disposed along the surface (mounting surface) of a circuit board. The housing has a terminal holding portion in the shape of a wall. The terminal fittings are press-fitted into and held by this terminal holding portion in a state where the terminal fittings pass through the terminal holding portion.

### SUMMARY

Although not illustrated in JP 2021-114378 A, the terminal holding portion of the housing is usually provided with inclined guide surfaces that guides the insertion of the terminal fittings. However, if the terminal holding portion of a housing is provided with guide surfaces, there will be a corresponding reduction in the area of the terminal holding portion used to hold the terminal fittings. If suitable area cannot be secured for holding the terminal fittings, there is the risk of problems such as the terminal fittings lifting off the surface of a circuit board during a reflow process, resulting in deterioration in coplanarity and the risk of mounting defects.

For this reason, it is an object of the present disclosure to provide a connector that is less susceptible to mounting defects on a circuit board, even when a housing is provided with guide surfaces for guiding terminal fittings.

A connector according to an aspect of the present disclosure is a connector including a housing and a terminal fitting, wherein the housing includes: a wall portion with a thickness in a first direction; a retaining hole that extends inside the wall portion in the first direction; guide surfaces that extend at an angle from a first surface in the first direction of the wall portion toward a second surface so as to approach each other in a second direction that intersects the first direction; facing surfaces that face in a same direction as the first surface and are disposed to form a pair in a third direction that intersects the first direction and the second direction at an intermediate part in the first direction of the wall portion; and movement suppression surfaces that extend along the first direction between the guide surfaces of the wall portion and the facing surfaces, the terminal fitting includes: a board connection portion that is connected to a circuit board outside the housing; a retained portion that is held in the retaining hole; and stopper portions that are disposed facing the facing surfaces in the first direction in a space that is closer to the first surface than the facing surfaces, and the stopper portions are disposed between the movement suppression surfaces, which form a pair in the second direction, in a state where movement in the second direction is suppressed.

According to an aspect of the present disclosure, it is possible to provide a connector that is less susceptible to mounting defects on a circuit board, even when a housing is provided with guide surfaces for guiding terminal fittings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to a first embodiment as seen from the front.

FIG. 2 is a perspective view of the terminal fitting of a connector according to the first embodiment as seen from the rear.

FIG. 3 is a rear view of the connector according to the first embodiment.

FIG. 4 is an enlarged perspective view of a retaining hole provided in a wall portion of a housing of the connector according to the first embodiment and a periphery thereof.

FIG. 5 is an enlarged rear view of a part of a wall portion of a housing of the connector according to the first embodiment where a terminal fitting is mounted.

FIG. 6 is a cross-sectional view of the connector according to the first embodiment taken along a line A-A in FIG. 5.

FIG. 7 is a cross-sectional view of the connector according to the first embodiment taken along a line B-B in FIG. 5.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Outline of Embodiments of the Present Disclosure

Several embodiments of the present disclosure will first be listed and described in outline.

(1) A connector according to an aspect of the present disclosure is a connector including a housing and a terminal fitting, wherein the housing includes: a wall portion with a thickness in a first direction; a retaining hole that extends inside the wall portion in the first direction; guide surfaces that extend at an angle from a first surface in the first direction of the wall portion toward a second surface so as to approach each other in a second direction that intersects the first direction; facing surfaces that face in a same direction as the first surface and are disposed to form a pair in a third direction that intersects the first direction and the second direction at an intermediate part in the first direction of the wall portion; and movement suppression surfaces that extend along the first direction between the guide surfaces of the wall portion and the facing surfaces, the terminal fitting includes: a board connection portion that is connected to a circuit board outside the housing; a retained portion that is held in the retaining hole; and stopper portions that are disposed facing the facing surfaces in the first direction in a space that is closer to the first surface than the facing surfaces, and the stopper portions are disposed between the movement suppression surfaces, which form a pair in the second direction, in a state where movement in the second direction is suppressed.

With the configuration according to (1) above, since the retained portion is held in the retaining hole and the stopper portions are disposed between the movement suppression surfaces that form a pair in the second direction in a state where movement in the second direction is suppressed, the terminal fitting can be properly assembled on the wall portion and can be held in a state where positional fluctuations are suppressed. As a result, it is possible to improve coplanarity and suppress the occurrence of mounting defects.

(2) In the connector according to (1) above, a dimension in the second direction of the stopper portions is preferably smaller than a separation distance in the second direction between the movement suppression surfaces that form a pair in the second direction.

With the configuration according to (2) above, since it is possible to prevent the stopper portions from contacting the movement suppression surfaces in the process of assembling (as one example, press-fitting) the terminal fitting into the housing, it is possible to reduce resistance during assembly, which facilitates the assembly of the terminal fittings.

(3) In the connector according to (2) described above, the movement suppression surfaces preferably form a pair in the third direction, and the wall portion preferably include, between the movement suppression surfaces that form a pair in the third direction, withdrawn surfaces that are recessed so as to become separated in the second direction from the movement suppression surfaces.

With the configuration according to (3) above, in the process of assembling the terminal fittings into the housing, since it is possible to avoid the retained portion contacting the withdrawn surfaces, it is possible facilitate assembly of the terminal fittings.

(4) In the connector according to (3) described above, the wall portion may preferably include inclined guide surfaces that extend at an angle from the withdrawn surfaces toward inner surfaces of the retaining hole so as to approach each other in the second direction.

With the configuration according to (4) above, it is possible, when assembly the terminal fittings onto the housing, for the retained portion to move smoothly from the withdrawn surfaces via the inclined guide surfaces to the inner surfaces of the retaining holes.

(5) In the connector according to (4) above, a separation distance between inner surfaces of the retaining hole that form a pair in the second direction may preferably be smaller than a separation distance of the movement suppression surfaces that form a pair in the second direction.

With the configuration according to (5) above, since it is possible to avoid the stopper portions from coming into contact with the movement suppression surfaces during the process of assembling the terminal fitting into the housing, this not only simplifies the assembly of the terminal fitting but also enables the retained portion to be in close contact with the inner surfaces of the retaining holes after the terminal fitting has been assembled. As a result, the state where the retained portion is held by the wall portion can be more favorably maintained.

### Detailed Description of Embodiments of the Present Disclosure

Specific embodiments of the present disclosure will now be described with reference to the drawings. However, the present invention is not limited to these examples, but rather is defined by the scope of the claims, and is intended to include all modifications within the meaning and scope equivalent to the claims.

### First Embodiment

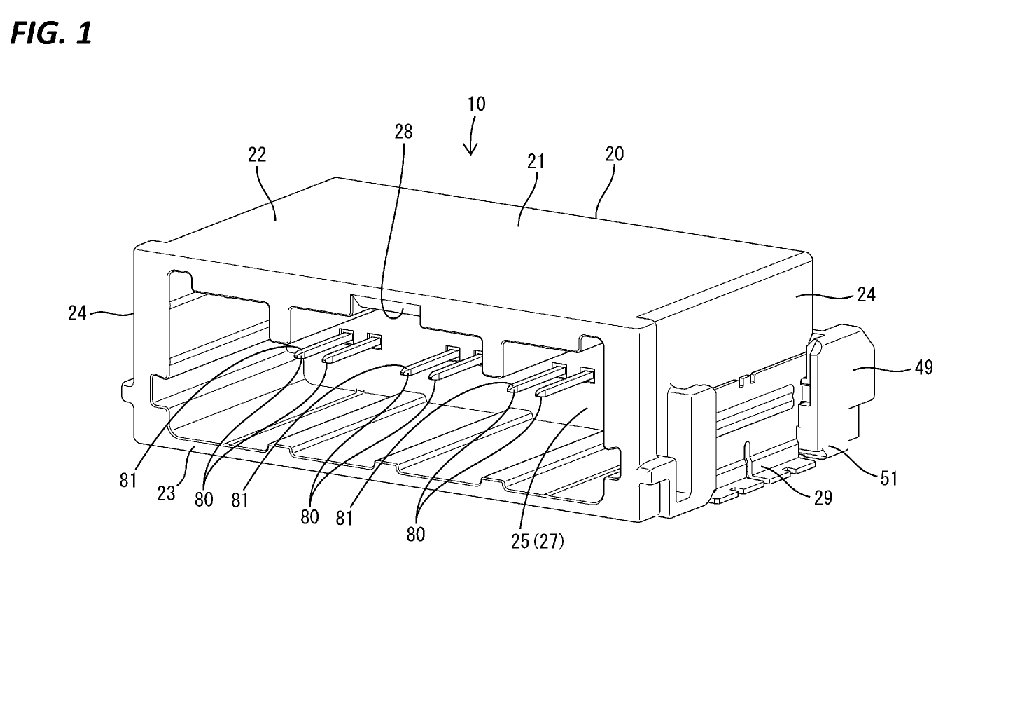

A connector 10 according to the first embodiment is a so-called "SMT connector" and, as depicted in FIG. 1, includes a housing 20 and terminal fittings 80. The housing 20 is mated with a mating housing, not illustrated. The terminal fittings 80 are mounted on the housing 20 and are connected to a circuit board 100 outside the housing 20. Note that in the following description, the front-rear direction may be referred to as the "first direction", the up-down direction as the "second direction", and the left-right direction as the "third direction". Here, the "front" refers to frontward in the first direction, and in this first embodiment corresponds to the direction (which may be angled slightly) in which the terminal fittings 80 are attached to the housing 20. "Right" in the present specification refers to frontward in the third direction and corresponds to the rightward direction as viewed from the rear. "Up" in the present specification refers to a leading end in the second direction and corresponds in this first embodiment to the direction (which may be angled slightly) in which the terminal fittings 80 are disposed relative to the circuit board 100 when mounted. The references used to express directions here have been chosen out of convenience and do not necessarily match actual directions when the connector 10 is actually installed in a vehicle or the like.

### Terminal Fitting 80

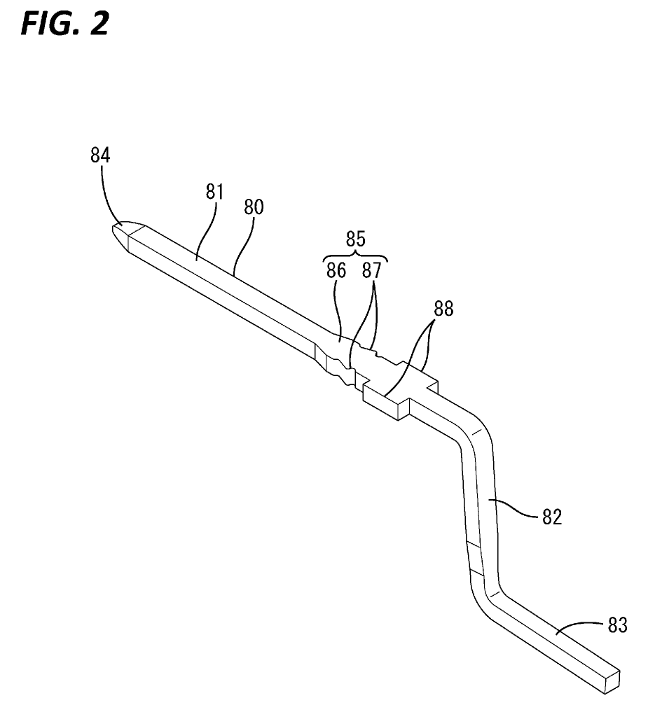

Each terminal fitting 80 is made of an electrically conductive metal and is shaped like a tab or a pin. As depicted in FIG. 2, each terminal fitting 80 includes a mating connection portion 81 that extends in the front-rear direction, an intermediate extension portion 82 that extends downward from a rear end of the mating connection portion 81, and a board connection portion 83 that extends rearward from a lower end of the intermediate extension portion 82.

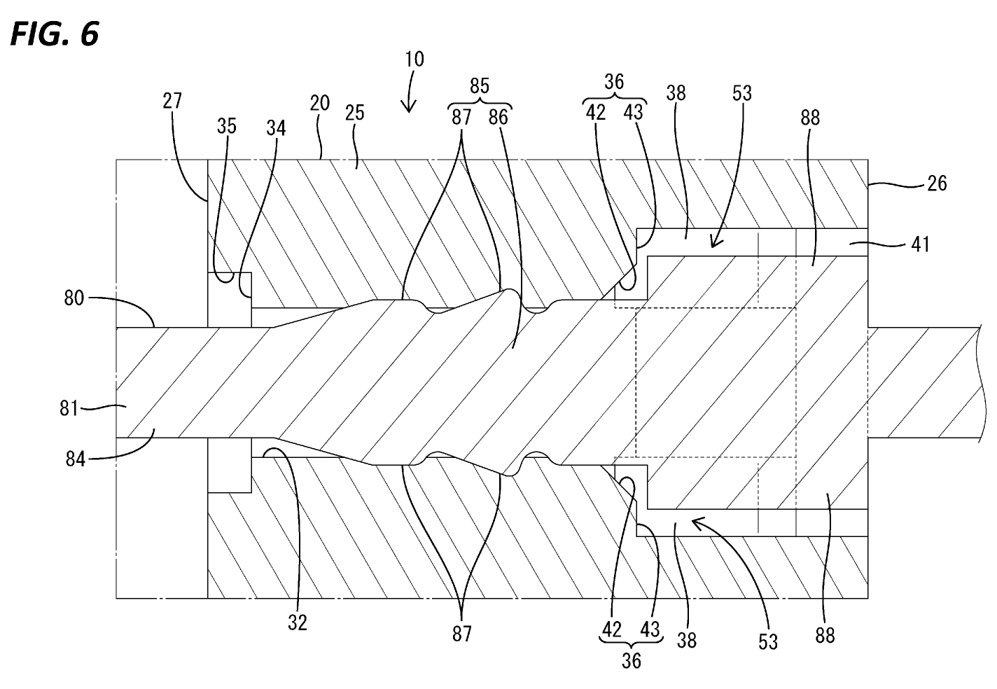

Each mating connection portion 81 is configured so that its dimension in the left-right direction is larger than its dimension in the up-down direction. Each mating connection portion 81 includes an extension portion 84 that extends continuously in the front-rear direction. A front end portion 89 of the mating connection portion 81 provided further forward than the extension portion 84 is tapered. The mating connection portion 81 also includes a retained portion 85, which is located in the rear of the extension portion 84 and near the rear end of the mating connection portion 81. As depicted in FIG. 6, this retained portion 85 is held by a wall portion 25, described later, of the housing 20. The retained portion 85 includes an intermediate portion 86 in the front-rear direction of the extension portion 84 and a plurality of protrusions 87 that protrude outward to the left and right from the intermediate portion 86 in the front-rear direction of the extension portion 84. The protrusions 87 are continuous with the same thickness in the up-down direction as the extension portion 84 and are aligned in the front-rear direction on the left and right end surfaces of the extension portion 84. The protrusions 87 are press-fitted into left and right inner surfaces of a retaining hole 32 (described later) of the housing 20.

The mating connection portion 81 includes a pair of left and right stopper portions 88, which are located in the rear of the retained portion 85 face surfaces 36 ( described later) of the housing 20 from the rear. As depicted in FIG. 2, each stopper portion 88 is shaped as a rectangular plate in plan view and is elongated in the front-rear direction relative to the left-right direction. The stopper portions 88 protrude outward to the left and right from an intermediate part in the front-rear direction of the extension portion 84 (that is, from a part in the rear of the intermediate portion 86). Each stopper portion 88 is continuous with the same thickness in the up-down direction with the extension portion 84. The lower surface of the board connection portion 83 is disposed along the surface of the circuit board 100.

### Housing 20

The housing 20 is made of synthetic resin and includes a hood portion 21 as depicted in FIG. 1. The hood portion 21 is shaped as a square tube and is open to the front. The hood portion 21 includes a top portion 22, a bottom portion 23, a pair of side portions 24, and a wall portion 25. The top portion 22 and the bottom portion 23 face each other in the up-down direction. The bottom portion 23 is located below the top portion 22 and rests on the surface of the circuit board 100. The side portions 24 face each other in the left-right direction. The left-right dimension of the top portion 22 and the bottom portion 23 is larger than the up-down dimension of each of the side portions 24. The wall portion 25 is disposed at a rear end of the housing 20. The wall portion 25 is connected to the rear ends of the top portion 22, the bottom portion 23, and the side portions 24. The thickness of the wall portion 25 is oriented in the front-rear direction. As depicted in FIG. 6, the rear surface of the wall portion 25 is configured as the "first surface 26", which is one end surface in the first direction, and the front surface of the wall portion 25 is configured as the "second surface 27", which is the other end surface in the first direction. Both the first surface 26 and the second surface 27 of the wall portion 25 are disposed along the up-down and left-right directions.

As depicted in FIG. 1, a locking portion 28 is provided to protrude into the hood portion 21 at a central part in the left-right direction of the top portion 22. The locking portion 28 engages with the mating housing, not illustrated, and keeps the two housings in a mated state. A pair of fixing brackets 29 (only one is depicted in FIG. 1) are attached to the outer surfaces in the left-right direction of the side portions 24. Each fixing bracket 29 is connected by soldering to the surface of the circuit board 100. The housing 20 is fixed to the circuit board 100 via these fixing brackets 29.

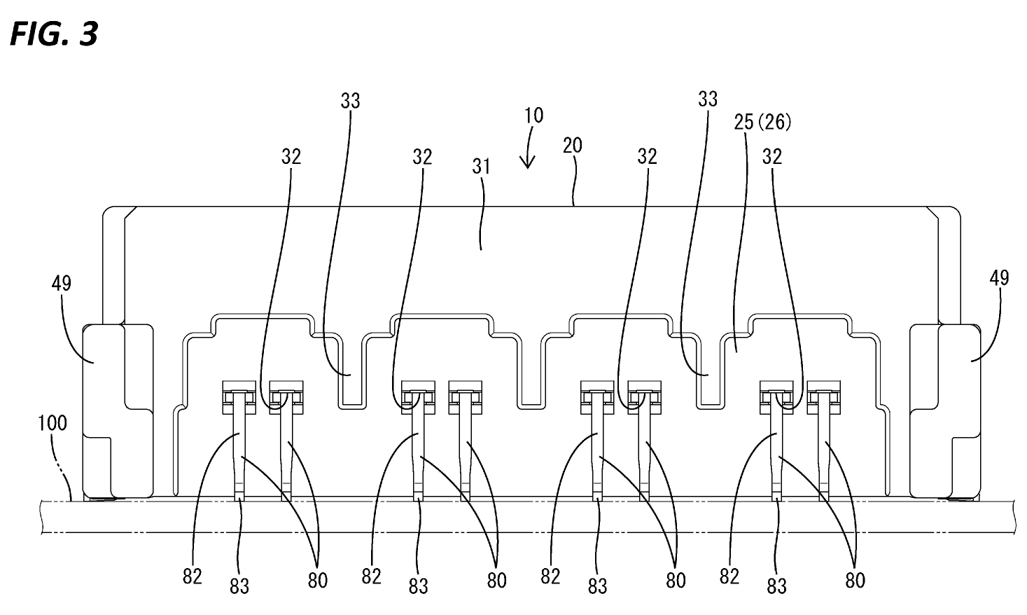

As depicted in FIG. 3, the upper portion of the wall portion 25 includes a protruding wall 31. The protruding wall 31 protrudes rearward from the first surface 26 and protrudes further to the rear than a lower portion of the wall portion 25. The lower portion of the wall portion 25 is provided with a plurality of retaining holes 32 that extend in the front-rear direction. The retaining holes 32 are aligned along the left-right direction on the wall portion 25. The wall portion 25 has a plurality of vertical walls 33 that extend downward from the protruding wall 31 between pairs of the retaining holes 32, which are provided in pairs in the left-right direction.

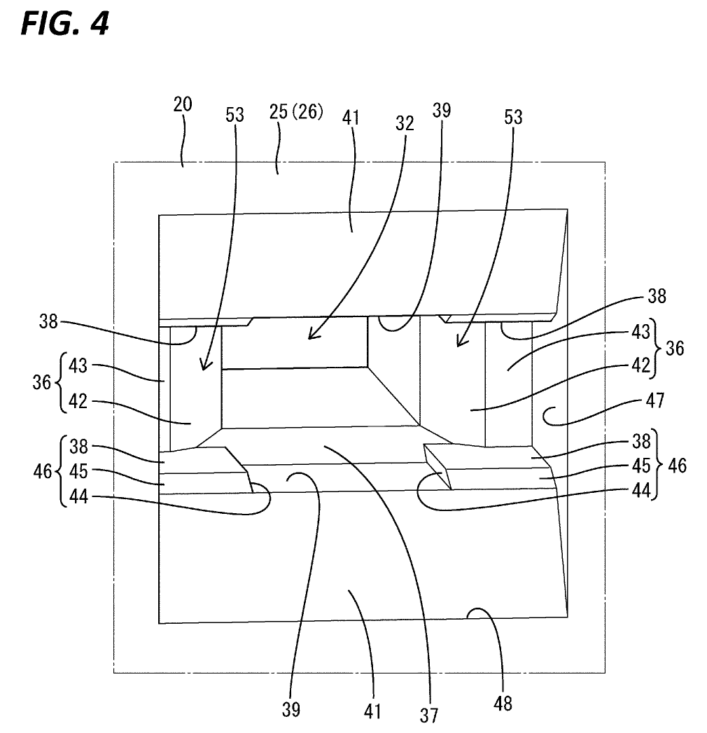

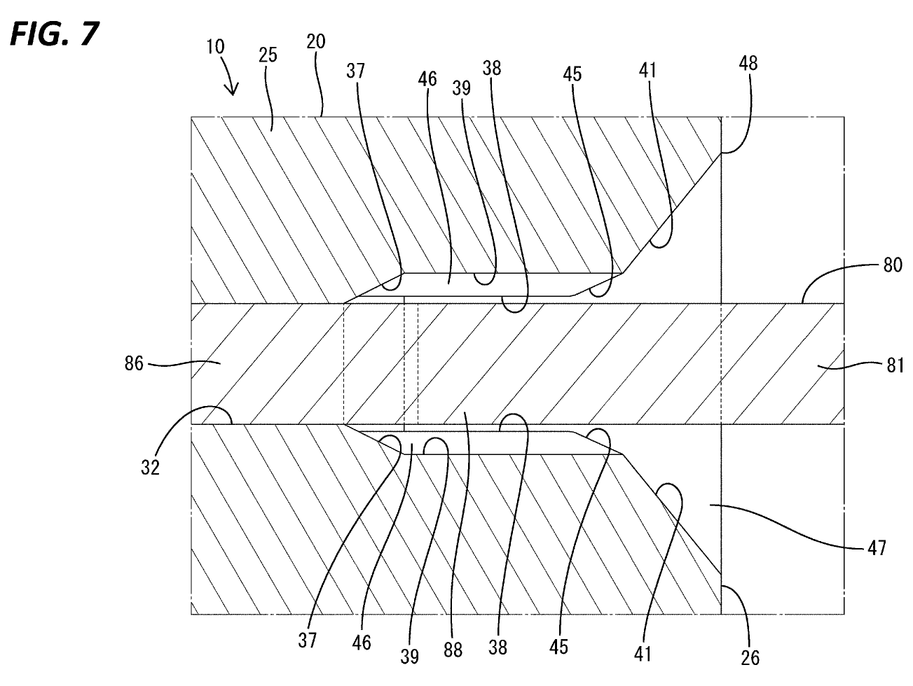

As depicted in FIG. 4, each retaining hole 32 has a rectangular cross-sectional shape that is longer in the left-right direction than in the up-down direction. The cross-sectional shape of each retaining hole 32 is constant in the front-rear direction. The separation distance between the upper and lower inner surfaces of each retaining hole 32 is the same as or slightly smaller than the up-down dimension of the retained portion 85 (see FIG. 7). The separation distance between the left and right inner surfaces (or "opening width") of each retaining hole 32 is greater than the left-right dimension of the extension portion 84 but is smaller than a distance in the left-right direction between the vertices of the protrusions 87 that form a pair in the left-right direction (see FIG. 6). The retained portion 85 of each terminal fitting 80 is press-fitted into a retaining hole 32 and is locked onto the wall portion 25 by the protrusions 87.

As depicted in FIG. 6, an expanded diameter surface 34, whose diameter is larger than the front end of the retaining hole 32, is provided at a position near the front end of the wall portion 25. The surface of the wall portion 25 from the expanded diameter surface 34 to the second surface 27 (that is, the front surface) of the wall portion 25 is a straight surface 35 that extends in the front-rear direction. This straight surface 35 is disposed so as to be separated from the extension portion 84.

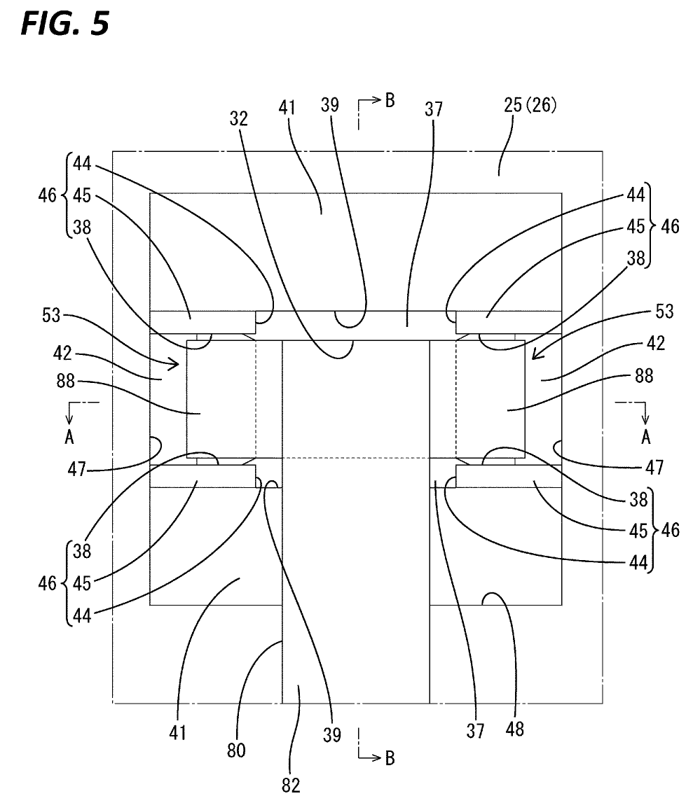

As depicted in FIGS. 4 and 5, the wall portion 25 includes the facing surfaces 36, inclined guide surfaces 37, movement suppression surfaces 38, withdrawn surfaces 39, and guide surfaces 41, between the rear ends of the retaining holes 32 and the first surface 26 (rear surface) of the wall portion 25. The facing surfaces 36 are disposed in pairs in the left-right direction. The movement suppression surfaces 38 are disposed in pairs in the left-right direction and in the up-down direction. The withdrawn surfaces 39, the inclined guide surfaces 37, and the guide surfaces 41 are each disposed in pairs in the up-down direction. Parts that correspond to the stopper portions 88 of a terminal fitting 80 are surrounded at their outer periphery by the facing surfaces 36, the movement suppression surfaces 38, the withdrawn surfaces 39, the inclined guide surfaces 37, the guide surfaces 41, and side inner surfaces 47.

The facing surfaces 36 face rearward, similarly to the first surface 26 of the wall portion 25. Each facing surface 36 includes a facing inclined surface 42, which slopes rearward from the rear end of the left and right inner surfaces of a retaining hole 32 and opens outward in the left-right direction, and a stepped surface 43, which extends in the left-right direction from the rear end (the outer end in the left-right direction) of the facing inclined surface 42. Each facing inclined surface 42 also widens in the up-down direction toward the rear.

As depicted in FIG. 7, each inclined guide surface 37 slopes from the rear ends of the upper and lower inner surfaces of a retaining hole 32 so as to open outward in the up-down direction and extends rearward. Each inclined guide surface 37 also widens in the left-right direction toward the rear. As depicted in FIG. 4, the outer ends in the left-right direction of the inclined guide surface 37 and the outer ends in the up-down direction of the facing inclined surfaces 42 extend radially and intersect each other. Each inclined guide surface 37 and each facing inclined surface 42 functions as a guide to guide the retained portion 85 of a terminal fitting 80 into the retaining hole 32.

Each movement suppression surface 38 is configured as a flat surface that extends in the front-rear and left-right directions. The front end of each movement suppression surface 38 is connected to the facing surfaces 36 and the inclined guide surfaces 37. In more detail, the front end of each movement suppression surface 38 is connected to the stepped surfaces 43 along the left-right direction and to the facing inclined surfaces 42 and the inclined guide surfaces 37 midway along their inclination. As depicted in FIG. 5, the separation distance in the up-down direction between the movement suppression surfaces 38 that form a pair in the up-down direction is slightly greater than the thickness in the up-down direction of the stopper portions 88. The movement suppression surfaces 38 closely face (oppose) the upper and lower surfaces of the stopper portions 88, and thereby suppress movement in the up-down direction of the stopper portions 88. The separation distance in the left-right direction between the movement suppression surfaces 38 that form a pair in the left-right direction is equal to the separation distance between the left and right inner surfaces of the retaining hole 32.

As depicted in FIGS. 4 and 5, the withdrawn surfaces 39 are disposed between the movement suppression surfaces 38 in the left-right direction. Each withdrawn surface 39 is configured as a flat surface that extends in the front-rear direction and the left-right direction. The dimension in the left-right direction of each withdrawn surface 39 is equal to the separation distance between the left and right inner surfaces of the retaining hole 32. An end surface 44 that extends in the up-down direction and the front-rear direction is interposed between each withdrawn surface 39 and each movement suppression surface 38. The withdrawn surfaces 39 are disposed so as to be outwardly recessed in the up-down direction from the movement suppression surfaces 38 via these end surfaces 44. The front ends of the withdrawn surfaces 39 are connected to the rear ends of the inclined guide surfaces 37. The inclined guide surfaces 37 extend at an angle from the front ends of the withdrawn surfaces 39 to the rear ends of the upper and lower inner surfaces of each retaining hole 32 so as to approach each other in the up-down direction. The upper and lower inner surfaces of each retaining hole 32 are reference surfaces for inserting a terminal fitting 80 into that retaining hole 32 and are positioned further inward in the up-down direction than the movement suppression surfaces 38.

As depicted in FIG. 7, the guide surfaces 41 extend forward from the first surface 26 of the wall portion 25 and taper toward each other in the up-down direction. The guide surfaces 41 are inclined with a greater angle of inclination relative to the front-rear direction than the inclined guide surfaces 37. The length of each guide surface 41 along the direction of inclination is shorter than the length of each movement suppression surface 38 in the front-rear direction and longer than the length of each inclined guide surface 37 in the inclined direction. As depicted in FIGS. 4 and 5, the dimension in the left-right direction of each guide surface 41 is greater than the separation distance between the left and right inner surfaces of the retaining hole 32 and is equal to the sum of the separation distance between the left and right inner surfaces of the retaining hole 32 and the dimension in the left-right direction of each facing surface 36.

The front ends of each guide surface 41 are continuous at the same height in the left-right direction. An intermediate part in the left-right direction of the front end of each guide surface 41 intersects the rear end of the withdrawn surface 39 at an obtuse angle. A short inclined surface 45 is interposed between each movement suppression surface 38 and both ends in the left-right direction (excluding the intermediate part) of the front end of a guide surface 41. As depicted in FIG. 7, each short inclined surface 45 extends from the front end of a guide surface 41 to a movement suppression surface 38, and is inclined at a smaller angle of inclination relative to the front-rear direction than the guide surfaces 41. As depicted in FIGS. 4 and 5, the dimension in the left-right direction of each short inclined surface 45 is equal to the dimension in the left-right direction of the movement suppression surfaces 38. The short inclined surfaces 45, the movement suppression surfaces 38, and the end surfaces 44 form flat block-shaped protrusions 46 between each guide surface 41 and each facing surface 36.

As depicted in FIGS. 4 and 5, an insertion opening 48, which is rectangular in rear view, and in more detail is square, is formed in the first surface 26 of the wall portion 25 and is located in the rear of the retaining hole 32. The insertion opening 48 is defined by a left and right pair of the side inner surfaces 47, which are vertical and extend in the up-down and front-rear directions, and the pair of upper and lower guide surfaces 41. The mating connection portion 81 of a terminal fitting 80 can be inserted into an insertion opening 48 in the wall portion 25 by guiding the tapered front end portion 89. Each side inner surface 47 intersects the outer ends in the left-right direction of the guide surfaces 41, the short inclined surfaces 45, the movement suppression surfaces 38, and the stepped surfaces 43.

As depicted in FIGS. 1 and 3, the housing 20 includes a pair of protective walls 49 (only one is depicted in FIG. 1) that protrude rearward from the ends in the left-right direction of the wall portion 25. The protective walls 49 are disposed to cover the intermediate extension portions 82 and the board connection portions 83 of the terminal fittings 80 from the outside in the left-right direction. As depicted in FIG. 1, the side portions 24 each have a pair of mounting wall portions 51 (only pair of mounting wall portions 51 is depicted in FIG. 1) that continuously extend forward from the protective walls 49. Part of each fixing bracket 29 is held by the pair of mounting wall portions 51.

### Operation of Connector 10

When assembling the terminal fittings 80 into the housing 20, the retained portion 85 of each mating connection portion 81 is inserted (press-fitted) into a retaining hole 32 while being guided from the insertion opening 48 by the guide surfaces 41, the short inclined surfaces 45, the movement suppression surfaces 38, the inclined guide surfaces 37, and the facing inclined surfaces 42. When the terminal fitting 80 has been assembled into the housing 20 at the proper position, the retained portion 85 is held so as to avoid coming out by the locking action of the protrusions 87 on the wall portion 25, and the part of the mating connection portion 81 that extends forward from the retained portion 85 becomes disposed so as to protrude into the interior of the hood portion 21 (see FIG. 1). The intermediate extension portion 82 and the board connection portion 83 are disposed so as to be rearwardly exposed from the housing 20 (see FIG. 3). As depicted in FIGS. 5 and 6, the stopper portions 88 are accommodated in a storage space 53 defined inside the wall portion 25 between the movement suppression surfaces 38, which form a pair in the up-down direction, and inside the inner sides of the side inner surfaces 47 on the left and right. The front ends of the stopper portions 88 are located rearward of and face the facing surfaces 36. When the mating connection portion 81 is excessively inserted into the wall portion 25, the stopper portions 88 will hit the stepped surfaces 43 of the facing surfaces 36, which prevents the mating connection portion 81 from being inserted any further. At appropriate timing, the fixing brackets 29 are also attached to both side portions 24 of the hood portion 21.

The connector 10 is placed on the surface of the circuit board 100. The board connection portion 83 of each terminal fitting 80 and each fixing bracket 29 are then placed on solder paste on the surface of the circuit board 100. After this, a reflow process is performed, which solders and fixes each fixing bracket 29 to the circuit board 100, and the board connection portion 83 of each terminal bracket 80 is soldered to the circuit board 100 and becomes electrically connected to a conductive portion, not depicted, of the circuit board 100.

To ensure coplanarity when performing the reflow process, it is necessary to dispose the board connection portion 83 of each terminal fitting 80 at an appropriate height (vertical position) above the surface of the circuit board 100. In this first embodiment, the wall portion 25 of the housing 20 includes the movement suppression surfaces 38, which extends in the front-rear direction between the guide surface 41 and the facing surface 36 and form a pair in the up-down direction. The upper and lower surfaces of the stopper portions 88 of the terminal fittings 80 face these movement suppression surfaces 38 that form a pair in the up-down direction, which results in the stopper portions 88 being disposed in the storage space 53 of the wall portion 25 in a state where movement in the up-down direction is suppressed. By suppressing movement in the up-down direction of each stopper portion 88 inside the wall portion 25 in this way, it is possible to maintain a state where the mating connection portion 81 of each terminal fitting 80 is properly assembled along the front-rear direction relative to the wall portion 25. By properly assembling the mating connection portion 81 of each terminal fitting 80 onto the wall portion 25, the board connection portion 83 of each terminal fitting 80 is positioned at the proper height before the reflow process is performed. Since the movement suppression surfaces 38 restrict the vertical fluctuations of the stopper portion 88, it is possible to achieve a state in which the board connection portions 83 of the terminal fittings 80 are properly soldered to the surface of the circuit board 100 even after the reflow process has been performed.

As described above, the connector 10 according to the first embodiment includes the housing 20 and the terminal fittings 80. The housing 20 includes the wall portion 25 with a thickness in the first direction (the front-rear direction), the retaining holes 32 that extend through the interior of the wall portion 25 in the first direction, the guide surfaces 41 that extend at an angle from the first surface 26 in the first direction of the wall portion 25 toward the second surface 27 so as to approach each other in a second direction (the up-down direction) that intersects the first direction, and the facing surfaces 36 that are disposed in a pair in a third direction (the left-right direction) that intersects the first direction and second direction at an intermediate part in the first direction of the wall portion 25 and face the same direction as the first surface 26. The housing 20 also includes the movement suppression surfaces 38 that extend along the first direction between the guide surfaces 41 and the facing surfaces 36 of the wall portion 25. The terminal fittings 80 each include the board connection portion 83 that is disposed along the surface of the circuit board 100 outside the housing 20, the retained portion 85 that is held in a retaining hole 32, and the stopper portions 88 that are disposed facing the facing surfaces 36 in the first direction in the storage space 53 at a position closer to the first surface 26 than the facing surfaces 36. The stopper portions 88 are disposed between the movement suppression surfaces 38 that form a pair in the second direction, in a state where movement in the second direction is suppressed.

With the above configuration, since the retained portion 85 is held in the retaining hole 32 and the stopper portions 88 are also disposed between the movement suppression surfaces 38 that form a pair in the second direction in a state that prevents movement in the second direction, each terminal fitting 80 can be properly assembled on the wall portion 25 and can be held in a state where positional fluctuations are suppressed. As a result, coplanarity can be improved and the occurrence of mounting defects can be suppressed.

In particular, since the dimension in the second direction of the stopper portions 88 is smaller than the separation distance in the second direction between the movement suppression surfaces 38 that form a pair in the second direction, contact between the stopper portions 88 and the movement suppression surfaces 38 can be avoided during the assembling of the terminal fittings 80 onto the housing 20, which facilitates assembly of the terminal fittings 80.

Also, since the movement suppression surfaces 38 form a pair in the third direction, and the wall portion 25 includes, between the movement suppression surfaces 38 that form a pair in the third direction, the withdrawn surfaces 39 that are recessed so as to be separated in the second direction from the movement suppression surfaces 38, contact between the retained portion 85 and the withdrawn surfaces 39 during the assembly process of the terminal fittings 80 onto the housing 20 can be avoided. As a result, assembly of the terminal fittings 80 can be performed more easily.

Also, since the wall portion 25 includes the inclined guide surfaces 37 that extend from the withdrawn surface 39 toward the inner surfaces of the retaining hole 32 at an angle approaching each other in the second direction, it is possible for the retained portion 85 to smoothly move from the inclined guide surfaces 37 to the inner surfaces of the retaining hole 32 during assembly of each terminal fitting 80 into the housing 20.

In addition, in the case of the first embodiment, the separation distance between the inner surfaces of each retaining hole 32 that form a pair in the second direction is smaller than the separation distance between the movement suppression surfaces 38 that form a pair in the second direction. This prevents the stopper portions 88 from coming into contact with the movement suppression surfaces 38 during the process of assembling the terminal fittings 80 into the housing 20, which not only simplifies the assembly of the terminal fittings 80 but also enables the retained portions 85 to be placed in close contact with the inner surfaces of the retaining holes 32 after the terminal fittings 80 have been assembled. As a result, the state where the retained portions 85 are held by the wall portion 25 can be more favorably maintained.

### Other Embodiments of the Present Disclosure

The above first embodiment disclosed in the present specification should be considered exemplary in all respects and is not restrictive for the present disclosure.

In the first embodiment described above, the connector is a horizontal connector in which the mating connection portions and the board connection portions of the terminal fittings extend in the front-rear direction and which is open in a direction of the surface of the circuit board. In contrast, according to another embodiment, the connector may be a vertical connector in which the mating connection portions and board connection portions of the terminal fittings extend in directions that intersect each other and the hood portion may be open in a direction that intersects the surface direction of the circuit board.

In the first embodiment described above, the stopper portions of the terminal fittings are disposed so as to be separated in the up-down direction from the movement suppression surfaces. In contrast, according to another embodiment, the stopper portions of each terminal fitting may be disposed so as to contact the movement suppression surfaces.

In the first embodiment described above, the stopper portions of the terminal fittings are disposed so as to be spaced rearward from the facing surfaces. In contrast, according to another embodiment, the stopper portions of the terminal fittings may be disposed so as to contact the facing surfaces.

In the first embodiment described above, the withdrawn surfaces are formed between the movement suppression surfaces that form a pair in the left-right direction. In contrast, according to another embodiment, the withdrawn surfaces may be omitted and the movement suppression surfaces may be formed continuously in the left-right direction.

In the first embodiment described above, the board connection portions of the terminal fittings are configured to be connected along the surface of the circuit board. In contrast, according to another embodiment, the board connection portions of the terminal fittings may be configured to be inserted into through-holes in the circuit board.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising a housing and a terminal fitting,
wherein the housing includes:
a wall portion with a thickness in a first direction;
a retaining hole that extends inside the wall portion in the first direction;
guide surfaces that extend at an angle from a first surface in the first direction of the wall portion toward a second surface so as to approach each other in a second direction that intersects the first direction;
facing surfaces that face in a same direction as the first surface and are disposed to form a pair in a third direction that intersects the first direction and the second direction at an intermediate part in the first direction of the wall portion; and
movement suppression surfaces that extend along the first direction between the guide surfaces of the wall portion and the facing surfaces,
the terminal fitting includes:
a board connection portion that is connected to a circuit board outside the housing;
a retained portion that is held in the retaining hole; and
stopper portions that are disposed facing the facing surfaces in the first direction in a space that is closer to the first surface than the facing surfaces, and
the stopper portions are disposed between the movement suppression surfaces, which form a pair in the second direction, in a state where movement in the second direction is suppressed.

2. The connector according to claim 1,
wherein a dimension in the second direction of the stopper portions is smaller than a separation distance in the second direction between the movement suppression surfaces that form a pair in the second direction.

3. The connector according to claim 2,
wherein the movement suppression surfaces form a pair in the third direction, and
the wall portion includes, between the movement suppression surfaces that form a pair in the third direction, withdrawn surfaces that are recessed so as to become separated in the second direction from the movement suppression surfaces.

4. The connector according to claim 3,
wherein the wall portion includes inclined guide surfaces that extend at an angle from the withdrawn surfaces toward inner surfaces of the retaining hole so as to approach each other in the second direction.

5. The connector according to claim 4,
wherein a separation distance between inner surfaces of the retaining hole that form a pair in the second direction is smaller than a separation distance of the movement suppression surfaces that form a pair in the second direction.
